(19) United States
(12) Patent Application Publication
(10) Pub. No.: US 2005/0044983 A1
(43) Pub. Date: Mar. 3, 2005

(54) Gear shifters scuff protector

(76) Inventor: Todd David Gordon, Miami, FL (US)

Correspondence Address: Todd David Gordon, 10622 S.W. 100 St., Miami, FL, 33176, US

(21) Appl. No.: 10/651,551

(22) Filed: Aug. 30, 2003

(51) Int. Cl. G05G 1/16

(52) U.S. Cl. 74/563

(57) ABSTRACT

An improved preventor of scuffing shoes while shifting gears on any motor vehilcle. This will allow for a more effective movement under the foot pedal with no worries Of scuffed or scraped shoes, totally helpful in engaging into the next gear.

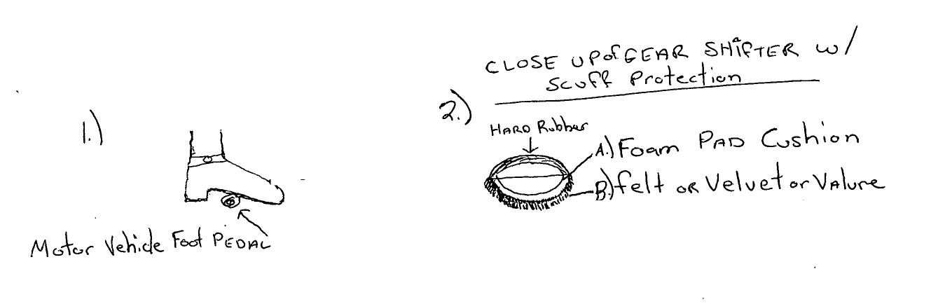

### BACKGROUND

1. Field of Invention

This invention will prevent scuffing of shoes on motor vehicle foot-gear shifters.

Specifically a protection designed for shoes worn by all riders of motor vehicles with gear shifters.

2. Description of Prior Art

Originally a motor cycle gear shifter is made of metal surrounded by hard rubber.

### SUMMARY

The essence of this invention . . . The metal gear shifting device totally covered with a soft material prevents any damage to the riders shoes.

No longer would the rider need to excessively shine, polish, or repair their shoes.

Saves time and money.

Further objectives and advantages of my invention will become apparent from a consideration of the drawings and ensuing description.

Description of drawing continued.

The metal foot shifter is totally covered in soft material.

Conclusion, Ramification and scope of invention.

This is concerning outfit of invention and can achieve cause.

It is totally user fiendly.

The invention scope is simply to protect shoes of the riders.

1. An item designed to protect rider's shoes.

2. The closure of claim 1 wherein . . . a piece of soft material surrounds The metal foot shifter on motor vehicles.

3. The closure of claim 1 wherein . . . the surface of the shoes are unable to be damaged.

4. The closure of claim 1 wherein . . . said damaging area will be resurfaced with non damaging material.
